(19) United States
(12) Patent Application Publication
(10) Pub. No.: US 2002/0004724 A1
(43) Pub. Date: Jan. 10, 2002

(54) Method for shipping temperature-sensitive goods

(76) Inventor: Winthrop A. Eastman, SugarLand, TX (US)

Correspondence Address: BRYAN L. WHITE, Bracewell & Patterson, L.L.P., PO Box 61389, Houston, TX, 77208-1389, US

(21) Appl. No.: 09/899,661

(22) Filed: Jul. 5, 2001

Related U.S. Application Data
(60) Provisional application No. 60/215,965, filed on Jul. 5, 2000.

(51) Int. Cl. G06F 17/60

(52) U.S. Cl. 705/1; 705/26; 705/28

(57) ABSTRACT

A method for shipping temperature-sensitive goods comprises the steps of receiving an order from a customer for a shipping container designed to hold temperature-sensitive goods, ascertaining from the order an appropriate number of appropriately-sized containers needed, delivering the appropriate number of appropriately-sized containers, loading the goods into the container, determining alternative logistical solutions for delivering the goods based on dictated constraints, allowing the customer to select the logistical solution by which the goods will be delivered, implementing a shipping schedule based on the logistical solution selected by the customer, undertaking to deliver the goods according to the shipping schedule, monitoring, via shipment tracking data, the undertaking to deliver the goods, maintaining communication access to the shipment tracking data, delivering the goods to a desired destination, unloading the container, retrieving the container; and cleaning, inspecting, and making the container ready for future use.

This application claims the benefit of U.S. Provisional application No. 60/215,965 filed Jul. 5, 2000.

### BACKGROUND OF THE INVENTION

1. Field of the Invention

This invention relates to a method for shipping goods, and more particularly to a method for shipping temperature-sensitive goods.

2. Description of Prior Art

Prior art methods for shipping temperature-sensitive goods typically comprise at least the steps of a producer of the goods packing the goods in an insulated container along with a heat sink (or heat source) material, and having the packaged goods transported to a desired location. A problem of great concern is the amount of time available for shipping once the goods are packed. The producer may not know how long its package may sit on a loading dock, or the thermal environment to which the package is exposed. Thus, the producer has difficulty trying to estimate the appropriate amount of heat sink/source material to include. If too much is included, in anticipation of long delays or temperature extremes, the heat sink/source may itself become a problem because it absorbs/delivers too much heat, damaging the temperature-sensitive goods.

### SUMMARY OF THE INVENTION

The present invention uses an innovative method for shipping temperature-sensitive goods comprising the steps of receiving an order from a customer for a shipping container designed to hold temperature-sensitive goods, ascertaining from the order an appropriate number of appropriately-sized containers needed, delivering the appropriate number of appropriately-sized containers, loading the goods into the container, determining alternative logistical solutions for delivering the goods based on dictated constraints, allowing the customer to select the logistical solution by which the goods will be delivered, implementing a shipping schedule based on the logistical solution selected by the customer, undertaking to deliver the goods according to the shipping schedule, monitoring, via shipment tracking data, the undertaking to deliver the goods, maintaining communication access to the shipment tracking data, delivering the goods to a desired destination, unloading the container, retrieving the container; and cleaning, inspecting, and making the container ready for future use.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

In the drawings:

FIG. 1 is a block diagram illustrating one embodiment of the present invention.

### DETAILED DESCRIPTION

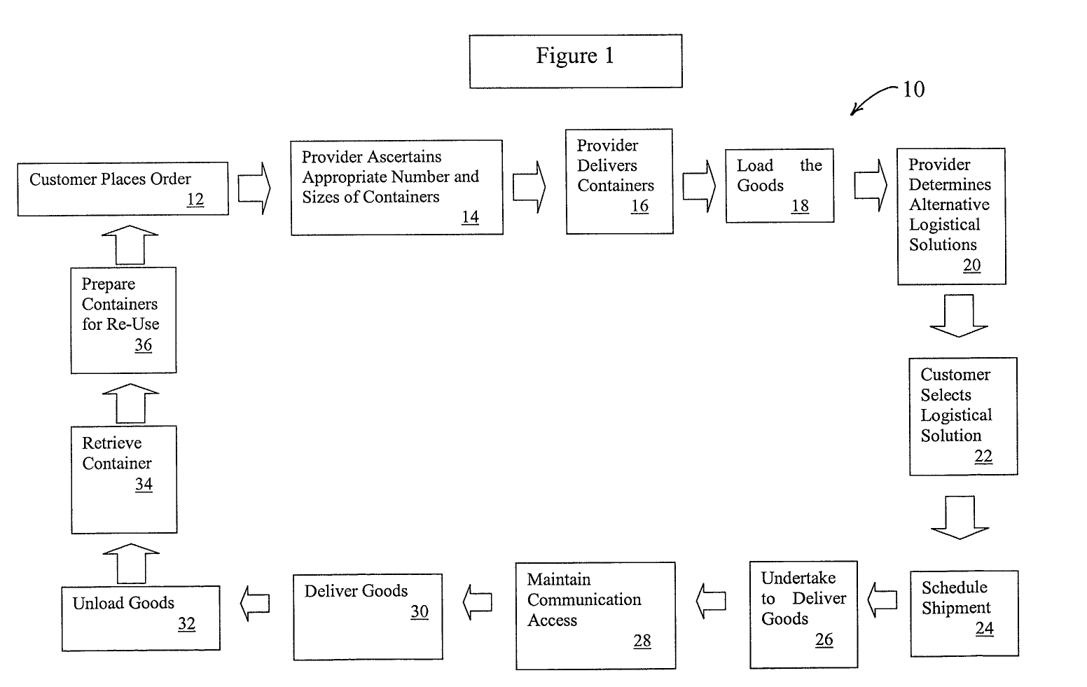

FIG. 1 illustrates a method for shipping temperature-sensitive goods 10 as one embodiment of the present invention. The method 10 is initiated when a customer places an order with the provider via a telephone or an online website interface 12. The order description gives the provider adequate information to ascertain the most appropriate number and size of containers to meet the customer's needs 14. The shipping containers can be simple thermally insulated boxes, but are preferably highly specialized, thermally insulated containers having built-in data monitors and thermal regulating features.

After receiving and processing the order, the provider delivers the ascertained appropriate number of appropriately-sized containers to the customer 16. The containers are generally fully charged and ready to receive temperature-sensitive goods when delivered to the customer. “Fully charged” means a heat sink used to absorb infiltrating heat is appropriately chilled (or a heat source used to supplement heat loss is appropriately heated).

Upon delivery of the containers, the provider, customer, or a third party loads the goods into the containers 18. The provider determines alternative logistical solutions and suggests the most efficient logistical solution to the customer 20. The alternative logistical solutions consider factors including, but not limited to, shipping time, type of transportation, costs, routes, and other constraints imposed by the customer. The customer chooses from the determined alternative logistical solutions 22 and shipment is scheduled 24. The provider, customer, or third party undertakes to deliver the goods 26.

During shipment, the provider, customer, or third party maintains communication access to shipment tracking data such as the container whereabouts or temperature information inside and outside the container 28. Those data are available to the provider, customer, or third party via real-time internet updates. Upon delivery 30 and transfer 32 of the goods, the containers are retrieved by the provider 34. The provider cleans, inspects and makes the containers ready for future use 36, whereupon the cyclic method 10 begins anew.

The present invention offers many advantages over the prior art. By using shipping containers that are highly specialized, thermally insulated containers having built-in data monitors and thermal regulating features, the paramount objective of maintaining tight temperature tolerances while shipping is achieved. Efficiency is gained by providing fully charged containers that are optimally chosen for the job at hand. The most cost-effective choice for shipping can be selected based on various constraints.

While the invention has been particularly shown and described with reference to a preferred and alternative embodiments, it will be understood by those skilled in the art that various changes in form and detail may be made therein without departing from the spirit and scope of the invention.

I claim:

1. A method for shipping temperature-sensitive goods comprising the steps of:
receiving, as a provider, an order from a customer for a shipping container designed to hold temperature-sensitive goods;
ascertaining from the order an appropriate number of appropriately-sized containers needed by the customer;
delivering the ascertained appropriate number of appropriately-sized containers to the customer;
loading the goods into the container;
determining alternative logistical solutions for delivering the goods based on constraints dictated by the customer;
allowing the customer to select the logistical solution by which the goods will be delivered from the determined alternative logistical solutions;
implementing a shipping schedule based on the logistical solution selected by the customer;
undertaking to deliver the goods to a desired location according to the shipping schedule;
monitoring, via shipment tracking data, the undertaking to deliver the goods according to the shipping schedule;
maintaining communication access to the shipment tracking data;
delivering the goods to the desired destination;
unloading the shipping container;
retrieving the container; and
making the container ready for future use.

2. The method of claim 1 in which the undertaking to deliver the goods is performed by the provider.

3. The method of claim 1 in which the undertaking to deliver the goods is performed by the customer.

4. The method of claim 1 in which the undertaking to deliver the goods is performed by a third party.

5. The method of claim 1 in which the monitoring of the undertaking to deliver the goods according to the shipping schedule is performed by the provider.

6. The method of claim 1 in which the monitoring of the undertaking to deliver the goods according to the shipping schedule is performed by the customer.

7. The method of claim 1 in which the monitoring of the undertaking to deliver the goods according to the shipping schedule is performed by a third party.

8. The method of claim 1 in which the maintaining communication access to the shipment tracking data is performed by the provider.

9. The method of claim 1 in which the maintaining communication access to the shipment tracking data is performed by the customer.

10. The method of claim 1 in which the maintaining communication access to the shipment tracking data is performed by a third party.

11. The method of claim 1 in which the making the container ready for future use includes cleaning the container.

12. The method of claim 1 in which the making the container ready for future use includes inspecting the container.

13. The method of claim 1 in which the making the container ready for future use includes cooling a heat sink material.

14. The method of claim 1 in which the making the container ready for future use includes heating a heat source material.
